(19) United States
(12) Patent Application Publication
(10) Pub. No.: US 2005/0068871 A1
(43) Pub. Date: Mar. 31, 2005

(54) System and method of determining optimum power for writing to an optical disc

(76) Inventor: Charles R. Weirauch, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/670,691

(22) Filed: Sep. 25, 2003

(51) Int. Cl. G11B 7/125

(52) U.S. Cl. 369/47.53

(57) ABSTRACT

A method of determining optimum power for writing to an optical disc comprises performing a power calibration test that comprises writing test data to a user data area on the optical disc, and reading the test data written to the user data area on the optical disc.

### TECHNICAL FIELD OF THE INVENTION

The present invention relates generally to the field of optical disc recording and more particularly to a system and method of determining optimum power for writing to an optical disc.

### BACKGROUND OF THE INVENTION

Optical discs have been used as the preferred data storage media for computers. While some optical discs are read-only such as CD-ROM (compact disk read-on-memory) and DVD (digital versatile disc), others, such as CD-R (compact disk recordable) and CD-RW (compact disk re-writable), DVD+RW (rewritable DVD disc) and DVD-RAM (digital versatile disc—random access memory) can be used by computer users to record data.

In general, the optimum power of the laser diode used to write to an optical disc is variable and depends on many factors. For example, properties of the optical disc, which may vary from disc-to-disc and from edge to edge or around a radius of each disc, affect the optimum laser power to write to the disc. Further, characteristics of the laser diode and its operating temperature also make laser power calibration necessary. Further, debris on, thermal, or mechanical stress on the optics or media can cause aberrations to the laser beam. Existing systems perform an optimum power calibration (OPC) by writing to an area on the optical disc that is not used for recording data. This test area is commonly termed the power calibration area (PCA) or OPC areas and occupies a region near the inner radius of the disc. Later, due to the recognition that the characteristics of the optical disc may be non-uniform across its surface, optimum power calibration is also done near the outer edge of the optical disc in the lead-out area. However, these two test regions are still remotely located from, and may have recording characteristics, the areas of the optical disc where data is recorded. Further, because optimum power calibration is performed periodically, the long seek time needed to position the laser at the power calibration area or lead-out area increases disc write time and slows down the overall operation of the system.

### SUMMARY OF THE INVENTION

In accordance with an embodiment of the present invention, a method of determining optimum power for writing to an optical disc comprises performing a power calibration test. The power calibration test comprises writing test data to a user data area on the optical disc, and reading the test data written to the user data area on the optical disc.

In accordance with yet another embodiment of the present invention, a system for determining optimum power for writing to an optical disc comprises a processor operable to direct a laser to write test data to a user data area on the optical disc, and directing a sensor to read the test data written to the user data area on the optical disc.

In accordance with another embodiment of the present invention, an article of manufacture comprises a computer-readable medium encoded with a process operable to perform a power calibration test. The process comprises writing test data to a user data area on an optical disc, and reading the test data.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified flowchart of an embodiment of an optimum power calibration test process according to the teachings of the present invention;

FIG. 2 is a schematic diagram of the regions on an optical disc;

FIG. 3 is a simplified block diagram of a system of optimum power calibration test according to the teachings of the present invention; and

FIG. 4 is a flowchart of an embodiment of a power re-calibration test process according to the teachings of the present invention.

### DETAILED DESCRIPTION OF THE DRAWINGS

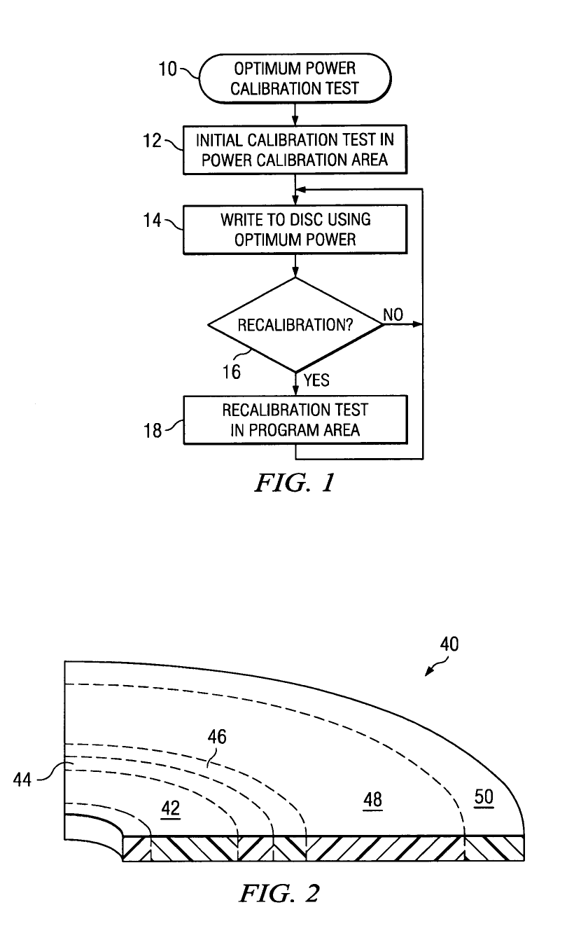

The preferred embodiment of the present invention and its advantages are best understood by referring to FIGS. 1 through 4 of the drawings, like numerals being used for like and corresponding parts of the various drawings.

FIG. 1 is a simplified flowchart of an embodiment of an optimum power calibration test process 10 according to the teachings of the present invention. Optimum power calibration test process 10 performs an initial calibration test, as shown in block 12. The initial power calibration test may be the same or similar to conventional calibration tests typically performed by writing to a power calibration area (PCA) 42 on optical disc 40, shown in FIG. 2, set aside for this purpose. Power calibration area 42 is located near the inner radius of optical disc 40. Proceeding outwardly from the center of optical disc 40, the next region is lead-in area 46, which contains disc information. In some optical formats, PCA 42 is considered to be part of the lead-in area. The next area following lead-in area 46 is the program area or user data area 48, which has the user written data tracks. A lead-out area 50, adjacent to the outer edge of optical disc 40, holds lead-out information, and can also include or be followed by a secondary power calibration area to conduct normal or high-speed power calibrations.

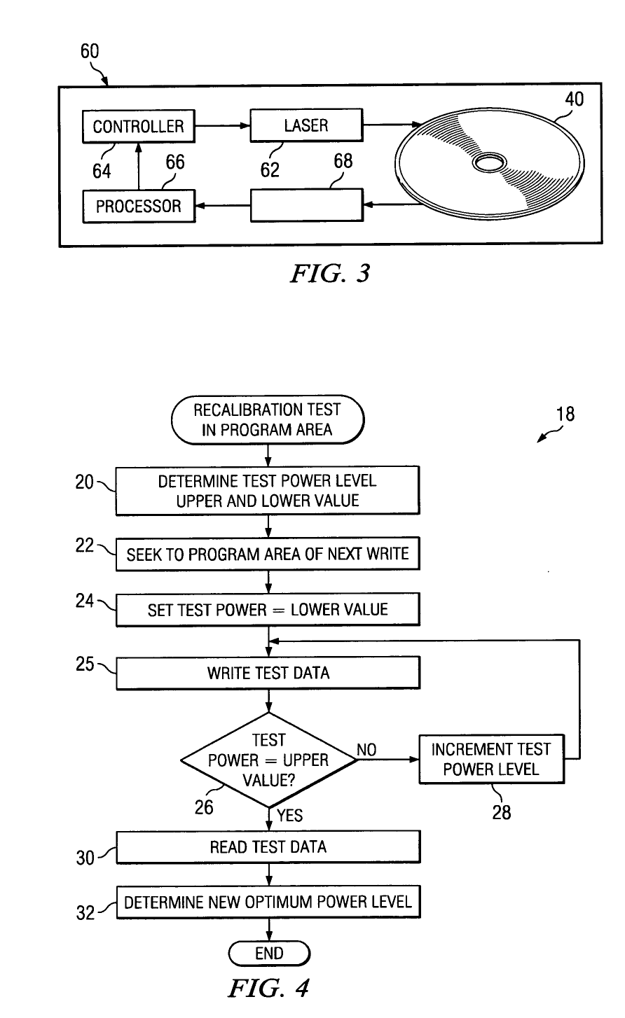

Referring also to FIG. 3 for a simplified block diagram of a system of optimum power calibration 60, the initial calibration test is typically performed on an optical disc 40 prior to the first write operation. During the initial calibration test, an initial recommended optimum recording power (RORP) estimate value is read from the absolute time in pregroove (ATIP) or address in pregroove (ADIP) information encoded in lead-in area 46 of optical disc 40. Using this estimated value, processor 66 determines a laser power test range that includes the estimated value. In some embodiments, the power test range may span three to four milliwatts or more. During the test, laser 62 writes test data to power calibration area 42 or lead-out area 50 while controller 64 steps the power of laser 62 through the power test range. A optical disc reader 68 then reads the test data. Typically, the test data is a predetermined test pattern the value of which is known to processor 66. Optical disc reader 68 may comprise a low power laser or light source that focuses the laser beam onto the marks and spaces formed on the recording surface of the optical disc. The reflected light from the marks and spaces is deciphered by a photodetector and associated electronics in optical disc reader 68 and is converted to data providing information about the different power values. Processor 66 determines, from the size and optical quality of the marks and spaces formed by laser 62 on the recording surface of optical disc 40, the optimum power setting for writing data to optical disc 40. As shown in block 14 in process 10, the determined optimum power setting is then used to write to optical disc 40 in subsequent write operations.

In block 16 of process 10, a determination is made as to whether one or more predetermined criteria for re-calibration have been met. For example, re-calibration of the laser power optimum setting may be desirable if system 60 (FIG. 3) has been performing many write operations over a period of time. The many write operations may cause the operating temperature of laser 62 to sufficiently increase to alter the operating wavelength of laser 62. Another exemplary criteria may be the location of the next write operation. The physical makeup of optical disc 40 may be non-uniform across its surface, so an optimum power setting determined near the inner or outer edges of the optical disc may not be optimum when writing to an user data area on the same disc. Therefore, the decision-making process in block 16 may determine whether to re-calibrate based on a number of factors that may alter the optimum power setting of laser 62. If the determination is “no,” then execution returns to block 14 to continue operations; however, if the determination is “yes” to re-calibration, then execution proceeds to block 18. The re-calibration process in block 18 is described in more detail in FIG. 4.

FIG. 4 is a flowchart of an embodiment of the power re-calibration test process 18 according to the teachings of the present invention. Process 18 may be carried out by hardware and/or software. In particular, process 18 may comprise software code that is executed by processor 66 and/or controller 64 (FIG. 3), for example. Power re-calibration process 18 is performed after the initial power calibration process and periodically thereafter as determined in process 10 in order to maintain the optimum laser power setting to write to the optical disc. In block 20, the range of power setting to be tested during re-calibration is determined. Because the new optimum power setting is unlikely to stray very far from the current optimum power setting determined in the initial power calibration process or previous re-calibration process, the recalibration test range preferably centers around the current optimum power setting. Therefore, the recalibration test range may be a substantially tighter range than that used in the initial calibration process. For example, if the last optimum recording power value is 20 milliwatts, instead of using a re-calibration power range of 18 to 22 milliwatts, the preferred embodiment of the invention sets the re-calibration power test range to, for example from approximately 5% below the current optimum power setting to approximately 5% above the current optimum power setting. Using the previous example, the re-calibration test range is then set to a predetermined range of 19 to 21 milliwatts, not 18 to 22 milliwatts. Alternatively, because laser efficiency decreases with higher temperature, the upper test range may be set at approximately 7% above the current optimum power setting, for example. The power test range for re-calibration may also be set in response to input from sensors (not shown). For example, a temperature sensor may be used to determine the operating temperature of the laser and/or optical disc. This sensed temperature may then be used to change the upper or lower value of the power test range. It should be noted that the above-enumerated percentages and ranges are provided as examples and may vary according to the laser and optical disc technology used.

In block 22, the write head of laser 62 seeks a location in the user data area on which to perform the power re-calibration process. Conventional re-calibration processes require testing to be done by writing to designated power calibration area or lead-out area not used for recording data because the laser power test range may span a setting that would damage the optical disc track or the recorded data in adjacent tracks. However, because the re-calibration process of some embodiments of the present invention uses a narrow re-calibration test range that centers around the current optimum power setting, the likelihood of damage is greatly reduced. Therefore, re-calibration may be performed in the user data area where data is recorded. Preferably, re-calibration is performed near the block or sector of the next write operation so that the optimum power setting may be determined according to the makeup of the optical disc at that location. Any sector not containing data can be used for writing re-calibration data. Alternatively, sectors containing data may be used for re-calibration by writing the data back to the sector after re-calibration. In addition to time savings derived from a narrower test range, this process also avoids long seeks to the inner or outer edge of the optical disc in order to perform the re-calibration test. In block 24, the test power is set to the lower value of the predetermined re-calibration power range. In block 25, test data is written to the user data area first using the test power setting. A determination is then made in block 26 as to whether the test power setting has reached the upper range previously determined in block 20. If the test power has not reached the upper limit, then the test power level is incremented in block 28. Otherwise, the re-calibration test has spanned the entire power test range and the test data may be read, as shown in block 30. The new optimum power setting is then determined in block 32 in response to detecting the reflectivity or the position and lengths of the marks and spaces made during the write process. This new power setting is then used in subsequent write operations until the next re-calibration test.

Because the laser power re-calibration process tests power settings within a narrow range about the current optimum power setting, it is less likely to introduce damage to the optical disc recording layer or the adjacent data tracks. Accordingly, it is permissible to perform the re-calibration test by writing test data to the data tracks in the user data area proximate to the sector and block for the next write operation. Performed in this manner, re-calibration can be done without long seeks to the power calibration area or lead-out area, thus improving the overall performance of the system. Because the re-calibration test is performed in the user data area near or at the location of the next write operation, the optimum power setting derived as a result also takes into account non-uniformity across the optical disc and is therefore more accurate.

In drives that currently employ constant angular velocity recording, extrapolation computation is needed because it is not possible to perform write operations to the lead-out area at the required velocity. The use of the re-calibration process in the user data area, according to embodiments of the present invention, now makes it unnecessary to perform extrapolation calculations.

System of optimum power calibration 60 may comprise a processor 66 that is located remotely from laser 62, controller 64, and/or optical disc reader 68. Processor 66 is operable to execute software code implementing processes 10 and 18 encoded onto computer-readable medium now known or later developed.

1. A method of determining optimum power for writing to an optical disc, comprising:
performing a power calibration test comprising:
writing test data to a user data area on the optical disc; and
reading the test data.

2. The method, as set forth in claim 1, further comprising determining a power test range spanning a current optimum power setting.

3. The method, as set forth in claim 2, further comprising determining the current optimum power setting.

4. The method, as set forth in claim 3, wherein determining the current optimum power setting comprises performing an initial power calibration test using an initial power test range.

5. The method, as set forth in claim 1, wherein writing test data to a user data area comprises writing the test data in response to the determined power test range.

6. The method, as set forth in claim 1, further comprising determining a new optimum power setting in response to reading the test data.

7. The method, as set forth in claim 2, wherein determining a power test range comprises:
setting a lower power test value to a predetermined percentage below the current optimum power setting; and
setting an upper power test value to a predetermined percentage above the current optimum power setting.

8. The method, as set forth in claim 2, wherein determining a power test range comprises:
setting a lower power test value to approximately 5% below the current optimum power setting; and
setting an upper power test value to approximately 5% above the current optimum power setting.

9. The method, as set forth in claim 4, wherein determining a power test range comprises setting the power test range less than the initial power test range.

10. The method, as set forth in claim 2, wherein determining a power test range comprises setting the power test range to span a predetermined amount of power.

11. The method, as set forth in claim 2, wherein determining a power test range comprises setting the power test range to span approximately 2 milliwatts.

12. The method, as set forth in claim 1, wherein writing test data to a user data area comprises writing test data to a location of the next write operation.

13. The method, as set forth in claim 1, wherein writing test data to a user data area comprises writing test data to a location proximate to the next write operation.

14. The method, a set forth in claim 1, wherein the power calibration test is performed periodically.

15. The method, a set forth in claim 1, wherein the power calibration test is repeated upon meeting a predetermined criteria.

16. The method, as set forth in claim 1, wherein the power calibration test is repeated in response to detecting a rise in temperature of the optical disc.

17. A system for determining optimum power for writing to an optical disc, comprising:
a processor operable to perform a power calibration test comprising:
directing a laser to write test data to a user data area on the optical disc; and
directing a sensor to read the test data written to the user data area on the optical disc.

18. The system, as set forth in claim 17, wherein the processor is operable to determine a power test range spanning a current optimum power setting.

19. The system, as set forth in claim 18, wherein the processor is operable to determine the current optimum power setting.

20. The system, as set forth in claim 18, wherein the processor is operable to perform an initial power calibration test to determine the current optimum power setting.

21. The system, as set forth in claim 18, wherein the processor is operable to write the test data in response to the determined power test range.

22. The system, as set forth in claim 17, wherein the processor is operable to determine a new optimum power setting in response to reading the test data.

23. The system, as set forth in claim 17, wherein the processor is operable to determine a power test range by setting a lower power test value to a predetermined percentage below the current optimum power setting, and setting an upper power test value to a predetermined percentage above the current optimum power setting.

24. The system, as set forth in claim 17, wherein the processor is operable to direct the laser to write test data to a location of the next write operation in the user data area on the optical disc.

25. The system, as set forth in claim 17, wherein the processor is operable to direct the laser to write test data to a location proximate to the next write operation in the user data area on the optical disc.

26. An article of manufacture, comprising:
a computer-readable medium encoded with a process operable to perform a power calibration test comprising:
writing test data to a user data area on the optical disc; and
reading the test data.

27. The article of manufacture, as set forth in claim 26, wherein the power calibration test further comprises determining a power test range spanning a current optimum power setting.

28. The article of manufacture, as set forth in claim 27, wherein the power calibration test further comprises writing the test data in response to the determined power test range.

29. The article of manufacture, as set forth in claim 26, wherein the power calibration test further comprises determining a new optimum power setting in response to reading the test data.

30. The article of manufacture, as set forth in claim 27, wherein the power calibration test further comprises:
setting a lower power test value to a predetermined percentage below the current optimum power setting; and
setting an upper power test value to a predetermined percentage above the current optimum power setting.

31. The article of manufacture, as set forth in claim 26, wherein the power calibration test comprises writing test data to a location of the next write operation.

32. The article of manufacture, as set forth in claim 26, wherein the power calibration test comprises writing test data to a location proximate to the next write operation.

33. The article of manufacture, as set forth in claim 26, wherein the power calibration test is repeated upon meeting a predetermined criteria.
